(19) United States
(12) Patent Application Publication
(10) Pub. No.: US 2019/0012872 A1
(43) Pub. Date: Jan. 10, 2019

(54) GAME SYSTEM AND GAME CONTROL METHOD

(71) Applicant: SEGA SAMMY CREATION INC., Tokyo (JP)

(72) Inventors: Hiroyuki MIYANO, Tokyo (JP); Taiji SUGAI, Tokyo (JP)

(73) Assignee: SEGA SAMMY CREATION INC., Tokyo (JP)

(21) Appl. No.: 16/067,722

(22) PCT Filed: Jan. 21, 2016
(86) PCT No.: PCT/JP2016/051750

§ 371 Date: Jul. 2, 2018

(51) Int. Cl. G07F 17/32

(52) U.S. Cl. CPC G07F 17/323; G07F 17/3288; G07F 17/3211

(57) ABSTRACT

Provided is a game system wherein a display control section executes control in order to display a bet target display section for displaying a plurality of possible betting positions respectively denoting a plurality of possible bet targets, a jackpot winning position display section for prominently displaying, as a jackpot winning position, a position selected in a first draw from among the plurality of possible betting positions, and a win notification section for indicating that the jackpot has been won in accordance with a position determined in a second draw from among the plurality of possible betting positions and the jackpot winning position. As a result, technology for obtaining a more entertaining game is provided.

### CROSS-REFERENCE TO RELATED APPLICATIONS

This application is the U.S. national phase of the International Patent Application No. PCT/JP2016/051750 filed Jan. 21, 2016, the entire content of which is incorporated herein by reference.

### TECHNICAL FIELD

The present disclosure relates to a game.

### BACKGROUND

Various games are popular in casinos and the like. In the widely played dice game of Sic Bo, for example, a player predicts a sum or a combination of numbers on the upturned faces of three dice shaken by a dealer, places a bet by placing a chip or the like on a picture or a number displayed on an upper surface of a table, and earns a dividend depending on the numbers on the upturned faces of the dice. The upper surface of the table is divided into a plurality of areas so that the player can select a bet target by placing a chip or the like. For example, the upper surface of the table is divided into an area for predicting and placing a bet on the sum total or a combination of the numbers on the upturned faces of two of the three dice, an area for predicting and placing a bet on the sum of the three dice, an area for predicting and placing a bet on whether the sum of the numbers on the upturned faces of the three dice will be “large” (11 to 17) or “small” (4 to 10), and so on. The player places a bet while the dealer shakes the three dice with the dice covered by a lid. When the dealer declares that no more bets will be received (by saying “No more bets” or the like), the dealer removes the lid and reveals the numbers on the upturned faces of the dice, thus determining the outcome of the game.

In other well-known games, a jackpot (a big win) can be won when a predetermined condition is satisfied during the game. The condition for winning the jackpot may be that in a dice game, the dice have matching upturned faces, or in a slot machine game, identical pictures are aligned, for example. Japanese Patent Publication JP 2009-189802 A discloses a dice game in which a jackpot dividend is obtained when the upturned faces of the dice match.

### SUMMARY

In a conventional game, however, the condition for winning the jackpot is limited to a special condition that rarely occurs, such as matching upturned faces on dice, and therefore the player may not hold out much hope of winning the jackpot. It is therefore desirable to realize a more entertaining game by allowing the player to be more hopeful of winning the jackpot.

The present disclosure has been designed in consideration of the circumstances described above, and an object thereof is to provide technology for obtaining a more entertaining game.

### Solution to Problem

A game device according to the present disclosure comprises a display control section for executing control in order to display a bet target display section for displaying a plurality of possible betting positions respectively denoting a plurality of possible bet targets, a jackpot winning position display section for prominently displaying, as a jackpot winning position, a position selected in a first draw from among the plurality of possible betting positions, and a win notification section for indicating that the jackpot has been won in accordance with a position determined in a second draw from among the plurality of possible betting positions and the jackpot winning position.

A game control method according to the present disclosure is implemented in a game system having a control section, wherein the control section displays a plurality of possible betting positions respectively denoting a plurality of possible bet targets, prominently displays, as a jackpot winning position, a position selected in a first draw from among the plurality of possible betting positions, and indicates that the jackpot has been won in accordance with a position determined in a second draw from among the plurality of possible betting positions and the jackpot winning position.

### Advantageous Effects of Disclosure

According to the present disclosure, technology for obtaining a more entertaining game can be provided.

### BRIEF DESCRIPTION OF THE DRAWINGS

Various embodiments of the disclosure are illustrated in the drawings, in which:

FIG. 1 is a diagram showing a schematic configuration of a game system according to an embodiment.

FIG. 2 is a view showing an example of an outer appearance of a dice throwing device.

FIG. 3 is a block diagram showing an example of a system configuration of the dice throwing device.

FIG. 4 is a view showing an example of a schematic configuration of a dice blowing device.

FIG. 5 is a flowchart showing an example of dice throwing processing.

FIG. 6 is a block diagram showing an example of a system configuration of a master device.

FIG. 7 is a view showing an example of a display image on a live screen.

FIG. 8 is a perspective view showing an example of an outer appearance of a station device.

FIG. 9 is a perspective view showing an example of an interior structure of the station device.

FIG. 10 is a block diagram showing an example of a system configuration of the station device.

FIG. 11 is a view showing an example of a display image displayed on a display device.

FIG. 12 is a view showing an example of a betting board.

FIG. 13 is a conceptual diagram illustrating a regular betting operation.

FIG. 14 is a conceptual diagram illustrating a chip moving operation.

FIG. 15 is a conceptual diagram illustrating a chip overlapping operation.

FIG. 16 is a block diagram showing a part of a functional configuration of the master device.

FIG. 17 is a view showing examples of display images displayed on the display device.

FIG. 18 is a view showing examples of display images displayed on the display device.

FIG. 19 is a view showing examples of display images displayed on the display device.

FIG. 20 is a view showing examples of display images displayed on the display device.

FIG. 21 is a diagram showing an example of a processing flow executed in the master device.

### DETAILED DESCRIPTION

An embodiment of the present disclosure will be described in detail below. Note that the following embodiment is merely an example used to illustrate the present disclosure, and the present disclosure is not limited to this embodiment alone. Further, various amendments may be applied to the present disclosure within a scope that does not depart from the spirit thereof. Moreover, a person skilled in the art may employ embodiments in which respective elements to be described below are replaced by equivalents, and these embodiments are also included in the scope of the present disclosure. Furthermore, it is assumed, unless indicated otherwise, that positional relationships expressed where necessary in terms of up, down, left, right, and so on are based on the depictions in the drawings. Moreover, various dimensional ratios shown in the drawings are not limited to the illustrated ratios. Further, to facilitate understanding, an embodiment in which the present disclosure is realized using an information processing device for a game will be described below as an example, but as noted above, the present disclosure is not limited thereto.

### A. Embodiment 1

An embodiment 1 will be described below using a dice game system. Note, however, that the system that may be applied to this embodiment is not limited to a dice game system, and another game system with which a game other than a dice game can be played may also be applied thereto.

### A-1. Dice Game System

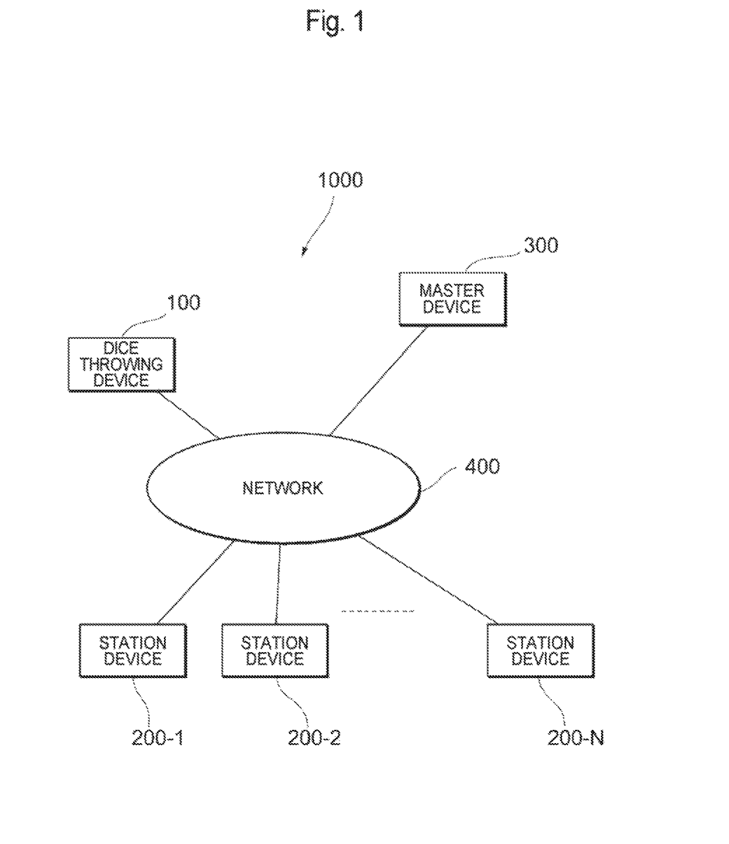

FIG. 1 is a schematic diagram showing a configuration of a preferred embodiment of the dice game system according to the present disclosure. A dice game system 1000 comprises a dice throwing device 100, a plurality of station devices 200-N (where N is a natural number no smaller than 2), a dice throwing device 100, and a master device 300. The dice throwing device 100 is a device for throwing dice during a dice game. The station devices 200-N are devices on which respective players perform betting operations during the dice game. The master device 300 is a device for controlling processing executed by the dice throwing device 100 and the respective station devices 200-N. The dice throwing device 100 and the master device 300 are connected via a network 400. The master device 300 and the respective station devices 200-N (referred to simply as the station devices 200 hereafter whenever there is no need to specify a particular station device) are also connected via the network 400. The network 400 is constituted by a network such as a LAN (Local Area Network) or the Internet.

A player participating in the game sits at an available station device 200. The player can play the dice game by predicting and placing bets on the numbers on the upturned faces of the dice, obtaining dividends depending on the actual numbers on the upturned faces, and so on.

### A-2. Dice Throwing Device

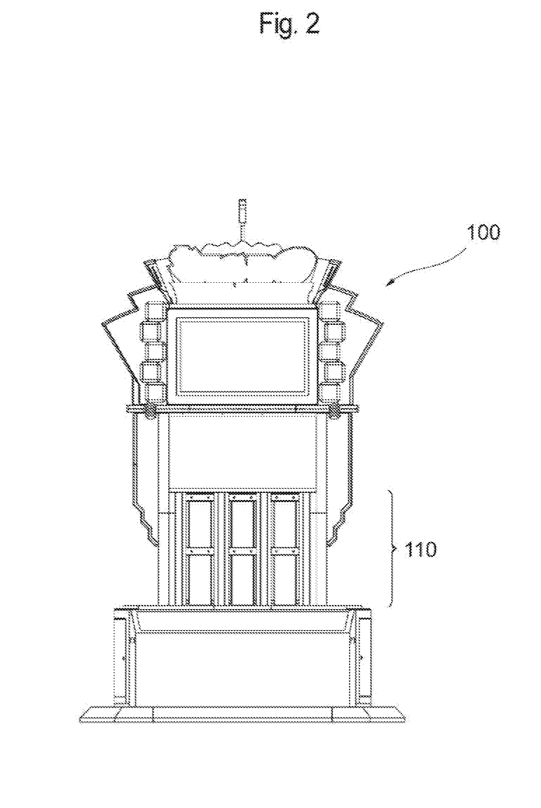

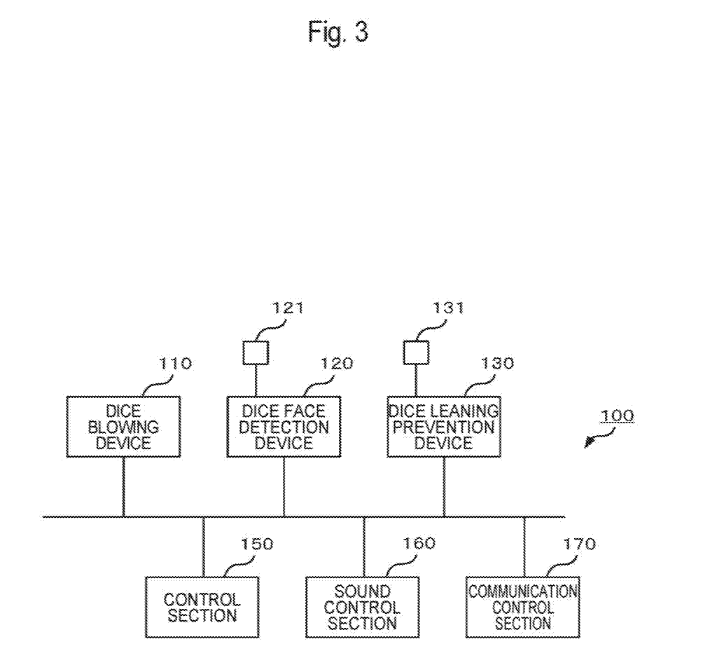

FIG. 2 is a view showing an outer appearance of the dice throwing device 100. FIG. 3 is a block diagram showing a system configuration of the dice throwing device 100.

As shown in FIG. 2, the dice throwing device 100 comprises a dice blowing device 110 that appears on the exterior thereof. As shown in FIG. 3, the dice throwing device 100 comprises, as the system configuration thereof, the dice blowing device 110, a dice face detection device 120, a dice leaning prevention device 130, a control section 150, a sound control section 160, and a communication control section 170. Although not shown in the drawings, the control section 150 comprises a CPU (Central Processing Unit), a ROM (Read Only memory), and a RAM (Random Access Memory). The control section 150 controls the processing executed by the respective configurations of the dice throwing device 100 by expanding and running a program stored in a storage section such as the ROM in the RAM. The sound control section 160 outputs sounds and so on for adding excitement to the progress of the game in accordance with blowing of the dice and so on. The communication control section 170 performs data communication with the master device 300.

The dice throwing device 100 performs a dice throw and so on in response to a dice blowing command, a throw start command (a throw command), and so on transmitted thereto from the master device 300 over the network 400, and transmits image data (referred to hereafter as “dice image data”) corresponding to the numbers on the upturned faces of the dice to the master device 300.

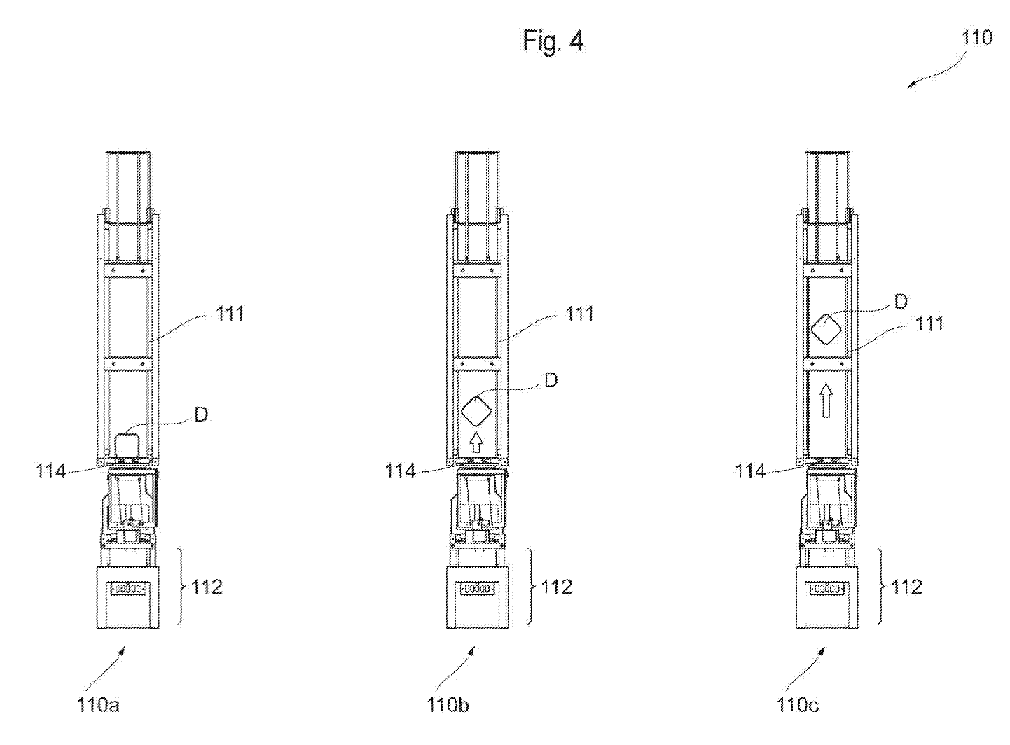

FIG. 4 is a view showing a schematic configuration of the dice blowing device 110. As shown in FIG. 4, the dice blowing device 110 is constituted by three dice blowing devices 110a to 110c. Each of the dice blowing devices 110a to 110c is provided with an opening corresponding to an inner diameter of a blowing pipe 111. Each of the dice blowing devices 110a to 110c comprises a blowing mechanism 112 having an air intake port, a shutter for opening and closing the air intake port, and a fan for taking in air through the air intake port. Further, a dice D that is lightweight, formed from plastic or the like, and has rounded edges is housed inside each of the dice blowing devices 110a to 110c. The dice D can be blown upward and rotated by the dice blowing device 110. The blowing pipe 111 is formed from a transparent material such as acrylic. The players and peripheral observers can watch the progress of operations to blow the dice D upward and stop the dice D through the blowing pipe 111.

Returning to FIG. 3, the dice face detection device 120 comprises an imaging device 121 such as an infrared camera or a CCD (Charge Coupled Device) sensor. After checking the numbers on the upturned faces of the dice D under the control of the control section 150 of the dice throwing device 100, the dice face detection device 120 photographs the numbers on the upturned faces of the dice D, which land on a dice table 114, and transmits captured dice image data to the master device 300.

The dice leaning prevention device 130 comprises a stepping motor 131 or the like, and forestalls a situation in which the dice D leans against an inner wall of the blowing pipe 111 (see FIG. 4) so that it is difficult to identify the number on the upturned face thereof by gently shaking the dice table 114 (see FIG. 4) on which the falling dice D lands using the stepping motor 131 or the like.

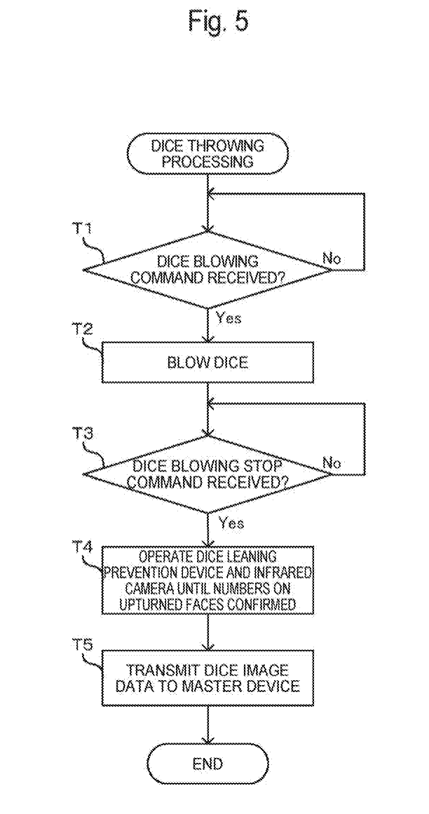

FIG. 5 is a flowchart showing dice throwing processing executed by the dice throwing device 100. The control section 150 of the dice throwing device 100, having received a command to blow the dice D upward from the master device 300 over the network 400 (step T1: YES), starts an operation for blowing the dice D upward using the dice blowing device 110 in order to blow the dice D upward (step T2). To blow the dice D upward, a motor or the like of the dice blowing device 110 is operated in order to open the shutter of the air intake port, and the operation to blow the dice D on the dice table 114 upward is started by operating the fan. As a result, the dice D are blown upward through the blowing pipe 111 while being rotated. Next, when the control section (a throwing section) 150 of the dice throwing device 100 receives a dice throwing command (in other words, a command to stop blowing the dice D upward) from the master device 300 over the network 400 (step T3: YES), the control section 150 stops the operation performed by the dice blowing device 110 to blow the dice D upward in order to allow the dice D to fall and check the numbers on the upturned faces thereof. In the dice blowing device 110, the air flowing into the fan is cut off by operating the motor or the like in order to close the shutter of the air intake port and switching a power supply of the fan OFF.

As a result, the airflow rising through the blowing pipe 111 is completely cut off so that the rotating dice D immediately fall through the blowing pipe 111 and land on the dice table 114. At this time, the control section 150 of the dice throwing device 100 uses the dice face detection device 120 to start photographing the numbers on the upturned faces of the dice D by means of the imaging device 121, and operates the dice leaning prevention device 130 to prevent the dice D from leaning against the inner surface of the blowing pipe 111 (step T4). The dice leaning prevention device 130 gently shakes the dice table 114 on which the dice D land using the stepping motor 131. Hence, the dice D remain stationary in a horizontal condition on the dice table 114 without leaning against the inner surface of the blowing pipe 111, and as a result, the numbers on the upturned faces of the dice D can be checked. The dice image data captured by the dice face detection device 120 are transmitted successively to the master device 300 from the communication control section (a communication section) 170 of the dice throwing device 100 over the network 400 (step T5).

### A-3. Master Device

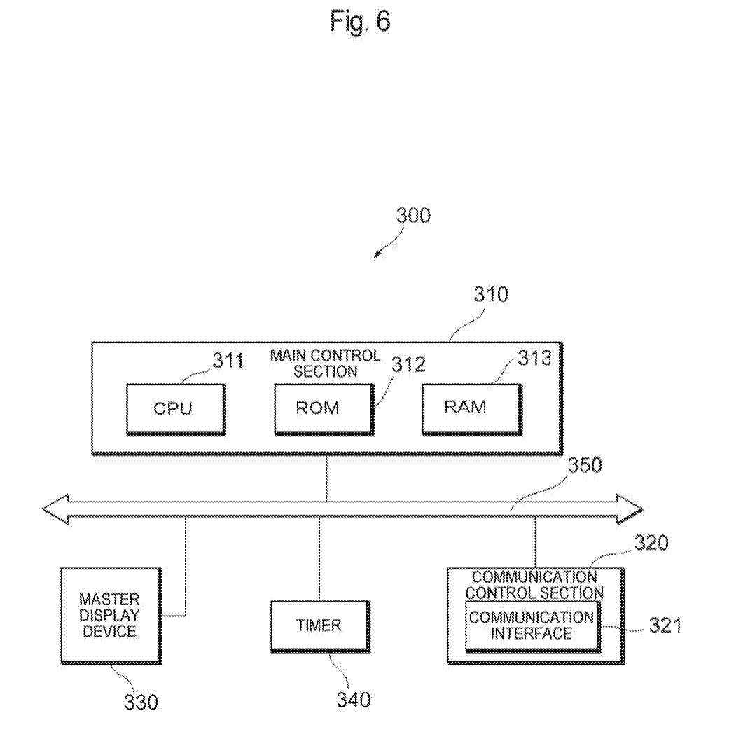

FIG. 6 is a block diagram showing a system of the master device 300. The master device 300 comprises a main control section 310, a communication control section 320, a master display device 330, and a timer 340.

The main control section 310 has a function for centrally controlling the master device 300, and comprises a CPU 311, a ROM 312, a RAM 313, and so on. The CPU 311 is connected to the timer 340 and so on via a bus 350. The main control section 310 exchanges data with the respective station devices 200 and the dice throwing device 100 via a communication interface 321. In the main control section 310, the CPU 311 controls processing executed by the respective configurations included in the master device 300 and an external device by expanding and executing data stored in the ROM 312 or data received from the external device in the RAM 313. In particular, the main control section 310 controls the progress of the dice game executed in the dice game system 1000.

An IPL (Initial Program Loader) that is run initially following introduction of a power supply is typically recorded in the ROM 312, and by running the IPL, a master device control program (software) and a dice game control program recorded on a disk or a memory device housed in or connected to a slot drive (not shown) are read temporarily to the RAM 313 by the main control section 310 and executed by the main control section 310. An operating system program required to control an overall operation of the master device 300 and so on are also recorded in the ROM 312.

The RAM 313 is used to store various programs and data temporarily, and the read master device program, data required for communication with the respective station devices 200 and communication with the dice throwing device 100, and so on are held therein. The dice image data received from the dice throwing device 100, dice face information obtained by analyzing the dice image data, and so on are also held in the RAM 313.

The communication control section 320 is a communication control section for connecting the master device 300 to the network 400. The communication control section 320 comprises the communication interface 321, which is constituted by a cable modem or the like for establishing a connection to the Internet or the like using a system that conforms to standards used to construct a LAN, for example.

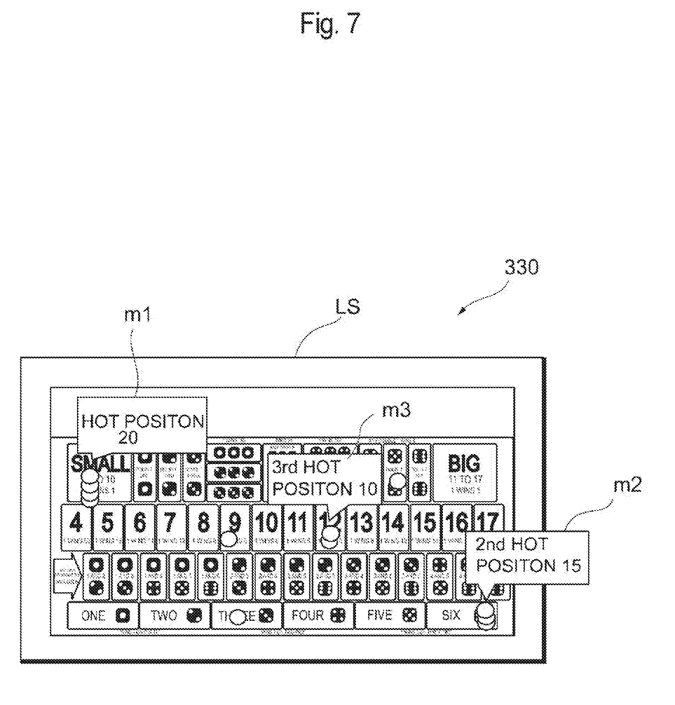

The master display device 330 displays an image (a live screen) LS representing the play of each player (respective betting statuses of the players and so on, for example), as shown in FIG. 7, for example, on the basis of betting information received from each of the station devices 200. Specifically, hot position display messages m1 to m3 are displayed on the live screen LS so that locations where first to M-th (in this embodiment, M=3) largest number of chips have been bet can be ascertained at a glance. More specifically, as shown in FIG. 7, a hot position message (“HOT POSITION” in FIG. 7) m1 and a number of credits (“20” in FIG. 7) are displayed on the live screen LS in relation to the betting position where the largest number of bets have been placed at the time. Similarly, a hot position message (“2nd HOT POSITION” in FIG. 7) m2 and a number of credits (“15” in FIG. 7) are displayed in the betting position where the second largest number of bets have been placed, and a hot position message (“3rd HOT POSITION” in FIG. 7) m3 and a number of credits (“10” in FIG. 7) are displayed in the betting position where the third largest number of bets have been placed. Note that although in this embodiment, hot position messages are displayed in the betting positions where the first to third largest numbers of bets have been placed, the number of positions in which to display hot position messages or the like may be set or modified as appropriate in accordance with the design of the master device 300 and so on.

Further, a frequency at which the live screen LS is updated may be set as appropriate in accordance with a frequency at which the betting information transmitted to the master device 300 from the respective station devices 200 is updated, and may be set at one second, for example. Alternatively, the live screen LS may be updated at an update timing of the betting information. The players can instantaneously ascertain the locations where the largest number of chips have been bet by looking at the live screen LS displayed by the master display device 330, and on the basis thereof, the players can modify the locations in which they have already placed bets or cancel their bets.

### A-4. Station Device

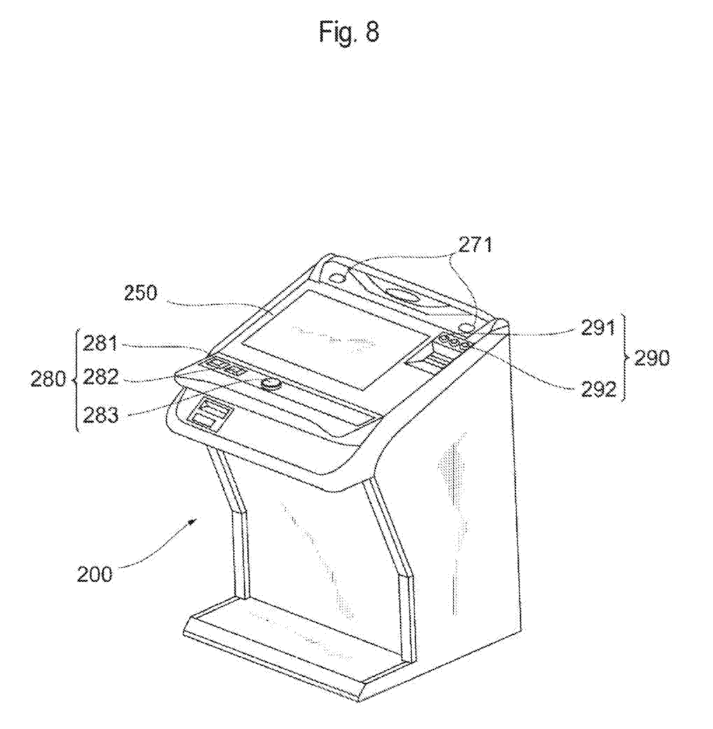

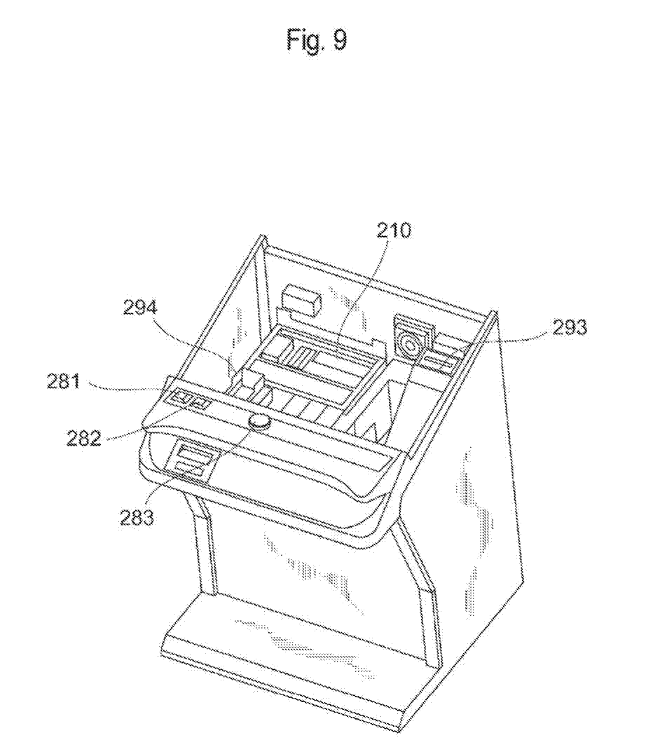

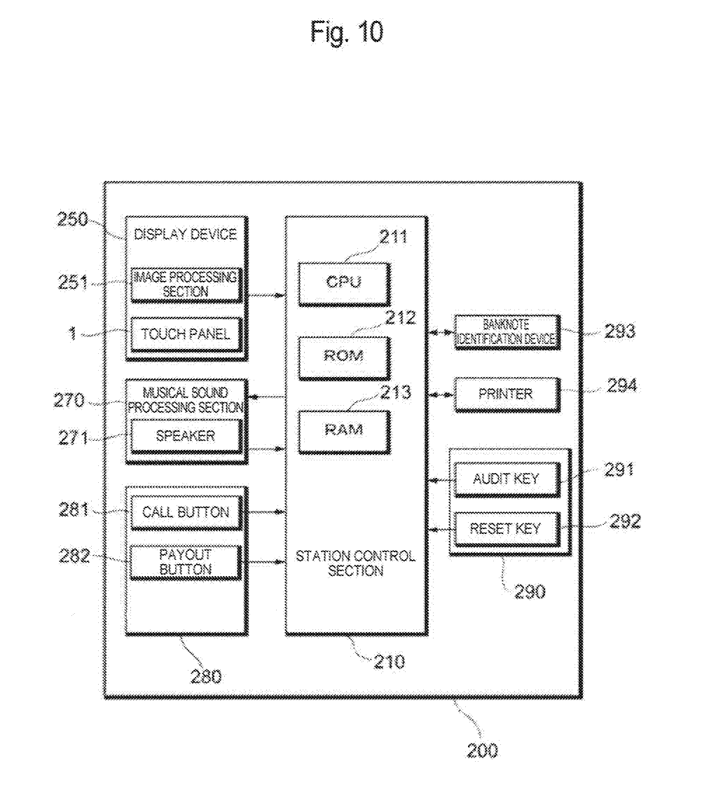

FIG. 8 is a view showing an example of an outer structure of the station device 200. FIG. 9 is a perspective view showing an example of an interior structure of the station device 200. FIG. 10 is a block diagram showing a system of the station device 200. Note that in FIGS. 8 to 10, corresponding parts have been allocated identical reference numerals, and duplicate description thereof has been omitted.

As shown in FIGS. 8 to 10, the station device 200 comprises, as main configurations, a station control section 210, a display device 250, a musical sound processing section 270, an operating button group 280, a setting key group 290, a banknote identification device 293, and a printer 294.

The station control section 210 comprises a CPU 211, a ROM 212, a RAM 213, and so on. The CPU 211 centrally controls the respective sections of the station device 200 by executing processing on the basis of various control programs and control data stored in the ROM 212 and the RAM 213. The ROM 212 and the RAM 213 store an algorithm required to calculate a dividend, display the dividend, and so on in each station device 200.

The display device 250 displays various screens, starting with a main screen, under the control of the station control section 210. An image processing section 251 connected to the display device 250 processes image data in accordance with an image control program (not shown), and then records the processed image data in a frame memory or the like. The image data recorded in the frame memory are converted into a video signal at a predetermined synchronization timing, and output to the display device 250. As a result, various images can be displayed.

Further, as shown in FIGS. 8 to 10, a touch panel 1 is provided on a front surface of the display device 250. The touch panel 1 is used to perform various operations relating to the dice game (a chip betting operation, operations to move and overlap bet chips, an operation to cancel a bet corresponding to a bet chip, and so on, as will be described in detail below).

The musical sound processing section 270 reads musical sound data or the like stored in the various memories or a storage medium, and by reproducing the read musical sound data, reproduces sound effects, musical compositions, and so on to accompany various animations. The generated sound effects and other musical sounds are output to the outside through a speaker 271.

The operating button group 280 comprises a call button 281 and a payout button 282. The call button 281 is an operating button for calling a member of staff when a problem or the like occurs. The payout button 282 is an operating button for requesting payout of tickets corresponding to a number of credits. These operating buttons are both configured to be operable by the player.

The setting key group 290 comprises an audit key 291 for test-operating the station device 200, and a reset key 292 that is operated when a member of staff pays out tickets or the like. These keys are configured to be settable and operable only by a person having specific authorization (an administrator of the dice game, a member of staff, or the like, for example).

The banknote identification device 293 is a device for identifying a type, a denomination, and so on of a banknote inserted through a cash insertion port when a player participates in the dice game. The printer 294 is a device for printing the tickets to be paid out at the end of the game or the like.

### A-5. Description of Basic Operations and Display Screens

Basic operations and display screens of the dice game that can be played using the dice game system 1000 will now be described. Screen display processing and processing executed in response to basic operations executed by the player, to be described below, are executed under the control of the station control section 210 and/or the main control section 310.

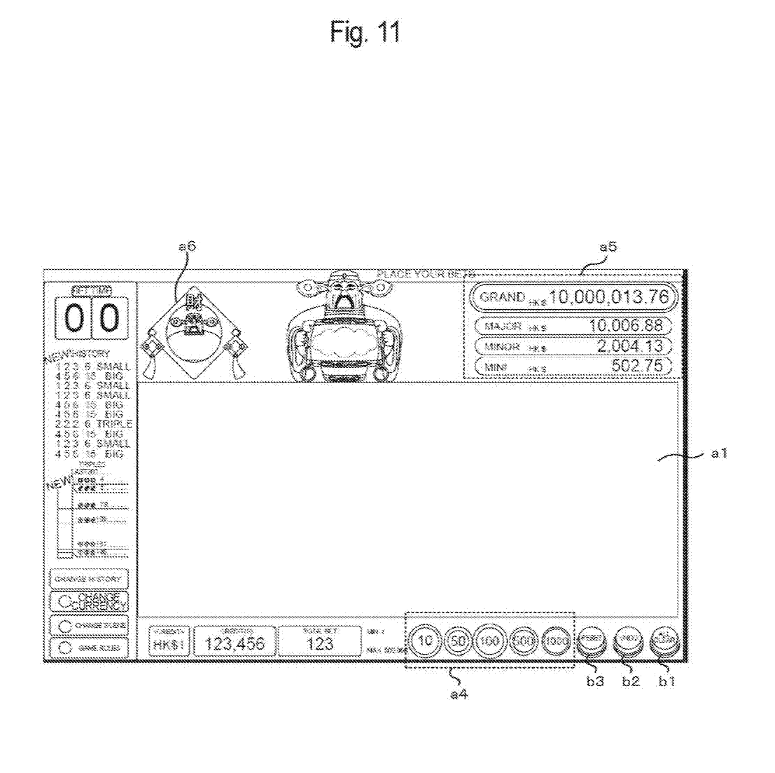

FIG. 11 shows an example of a screen displayed on the display device 250 during a period (referred to hereafter as a “betting time”) in which the dice game has started and the players can implement betting operations. Each of the players predicts the numbers on the upturned faces of the dice D, and implements a betting operation using the touch panel 1 on the display device 250 of the station device 200 allocated to the player. The player can implement the betting operation by performing an operation in a regular betting area a1.

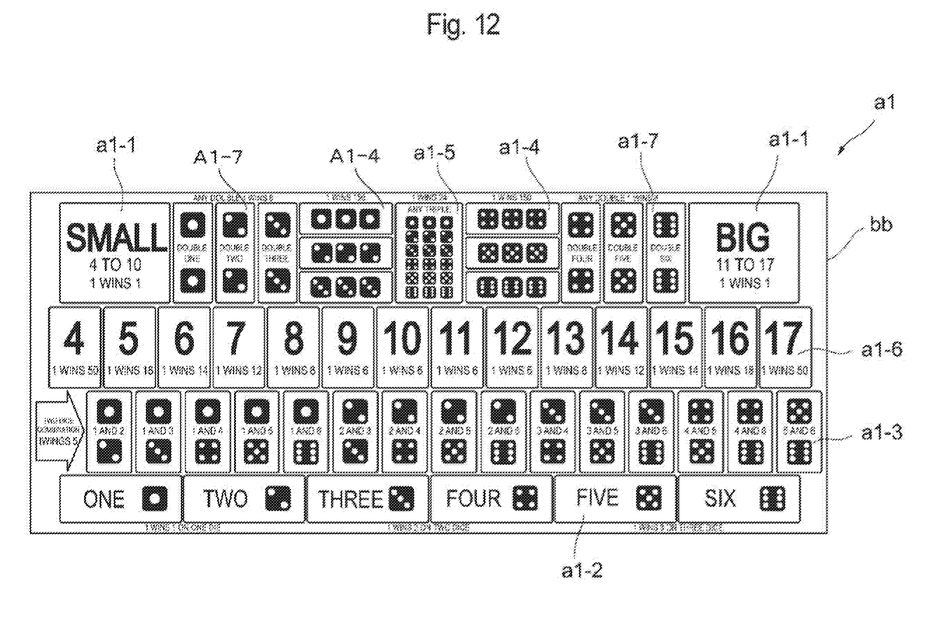

FIG. 12 shows an example of a betting board bb displayed in the regular betting area a1.

A Big/Small area a1-1 is an area in which to predict whether the total value of the three dice D will be “Big” or “Small” and place a bet thereon. When the player predicts that the total value of the three dice D will be “4 to 10”, the player places a bet by placing a chip on “Small”. When the player predicts that the total value of the three dice D will be “11 to 17”, the player places a bet by placing a chip on “Big”. Note that when three matching upturned faces (“1, 1, 1” or the like, for example) are thrown, the bet is lost.

A Specific Single Dice area a1-2 is an area in which to predict the number on the upturned face of one of the three dice D (in other words, a “single”) and place a bet thereon. The player can place a bet by placing a chip in an area displaying the number predicted to be on the upturned face within the Specific Single Dice area a1-2. A Specific Double area a1-3 is an area in which to predict the numbers on the upturned faces of two of the three dice D (in other words, a “double”) and place a bet thereon.

A Specific Triple area a1-4 is an area in which to predict a matching number on each of the upturned faces of the three dice D (in other words, a “triple”) and place a bet thereon. An Any Triple area a1-5 is an area in which to predict that the numbers on the upturned faces of all of the three dice D will match, without predicting the matching number (in other words, “any triple”), and place a bet thereon.

A Three Dice Total area a1-6 is an area in which to predict the total value of the three dice D (in other words, a “sum of the upturned faces”) and place a bet thereon. A Two Dice Combination area a1-7 is an area in which to predict the numbers on the upturned faces of two of the three dice D (in other words, a “combination of two”) and place a bet thereon.

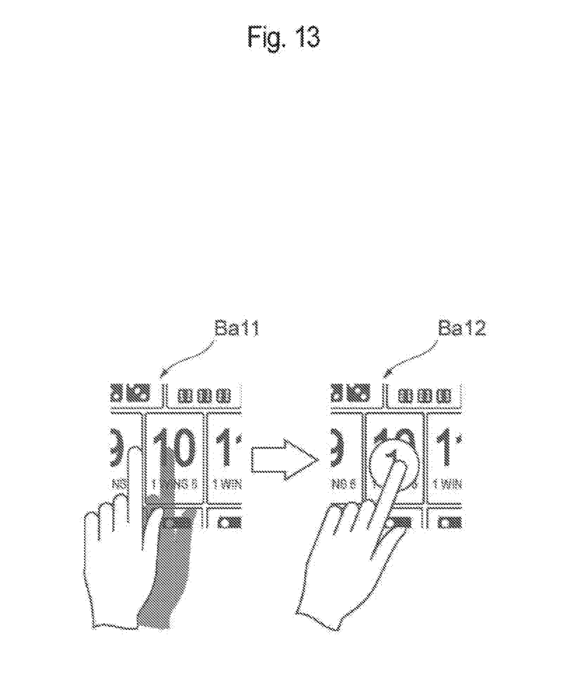

The dividends in the regular betting area a1 described above are set in advance using a game program or the like. For example, the dividend for a win in the Big/Small area a1-1 is 1:1 (one ticket is paid out for one bet, or in other words “1 WINS 1”), the dividend for a win in the Specific Double area a1-3 is 1:5, and so on. The station control section (a first determination section) 210, having received the face information from the master device 300, determines whether or not the regular game has been won by comparing the face information from the master device 300 with the numbers on the upturned faces of the dice that were specified in the regular betting operation. Note that in the following description, the areas in which bets can be placed will be referred to collectively as “betting positions”. Next, referring to FIG. 13 and so on, the regular betting operation will be described in detail.

### A-5-1. Betting Operation

The player performs a regular betting operation in a desired area (the Big/Small area or the like, for example) within the regular betting area a1 by operating the touch panel 1 using a finger or the like. More specifically, the player touches the location in which s/he wishes to place a bet (in FIG. 13, for example, “10” in the Three Dice Total area a1-6) (see Ba11 in FIG. 13). The moment the location is touched, a predetermined chip is placed (in other words, a bet is placed) in the location, whereby the regular betting operation is completed (see Ba12 in FIG. 13).

### A-5-2. Chip Moving Operation

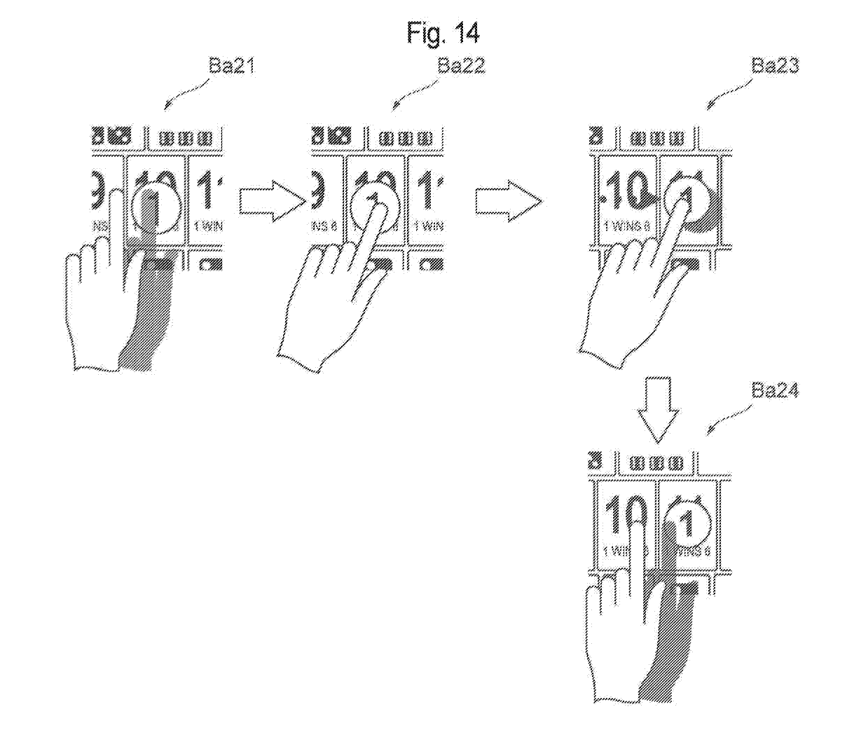

When the player touches a chip placed in the regular betting area a-1 continuously for at least a predetermined time (200 ms or more, for example), the chip becomes movable (Ba21→Ba22 in FIG. 14). In this condition, the player can move the chip to a desired location by moving his/her finger in a desired direction (a rightward direction in FIG. 14) (Ba23 in FIG. 14). Then, when the player removes his/her finger from the touch panel 1 in a movement destination, the chip stops moving and a new bet is placed in the corresponding position (Ba24 in FIG. 14).

### A-5-3. Chip Overlapping Operation

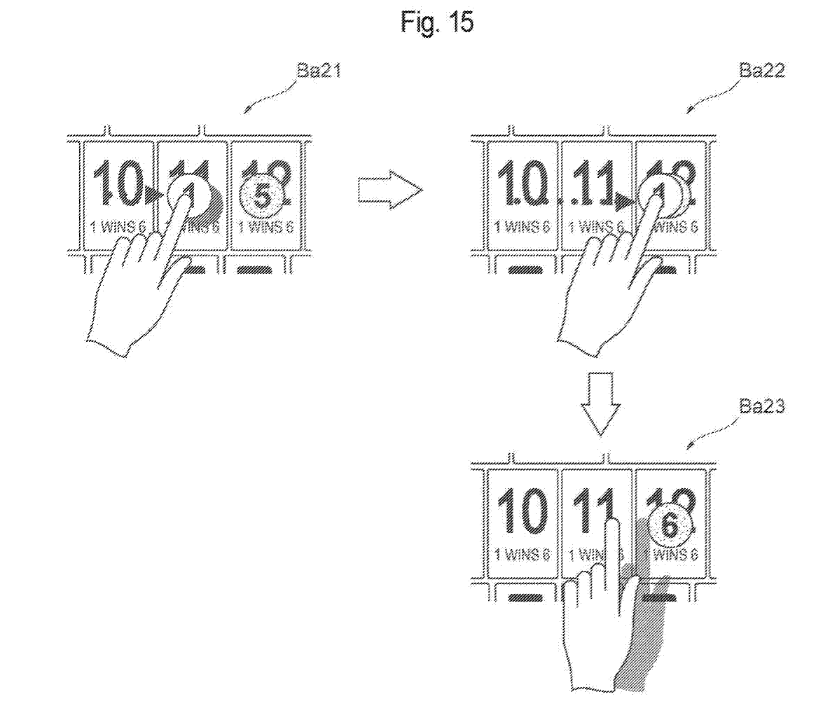

In a condition where a certain chip has already been bet, as shown in Ba31 of FIG. 15 (a chip denoting “5” credits in Ba31 of FIG. 15), the player moves another chip (a chip denoting “1” credit in Ba31 and Ba32 of FIG. 15) on top of the chip, and when the player then removes his/her finger, the two chips are added together, whereupon the total value of the chips (“6” credits in Ba33 in FIG. 15) is displayed and a new bet is placed in the corresponding position.

Note that when a chip is still being moved at the end of the betting time, the betting operation relating to the chip is handled as a canceled bet such that the chip being moved is deleted from the screen and the credits denoted by the deleted chip (“5” credits, for example) are returned to the credits held by the user.

### A-5-4. Chip Bet Cancelation Operation

When the player presses a clear button b1 in a condition where a chip has been placed in order to place a bet in the regular betting area a1, the bet corresponding to the chip is canceled, and display of the chip placed in the regular betting area a1 is deleted. At this time, the credits denoted by the deleted chip (“5” credits, for example) are converted into credits held by the user.

### A-5-5. Undo Operation

The player can undo (in other words, delete) an immediately preceding operation by pressing an undo button b2 shown in FIG. 11. Note that in this embodiment, setting is performed such that when the undo button b2 is pressed 10 or more times in succession, all of the regular betting operations implemented during the game are canceled, but this setting may be modified as appropriate in accordance with the settings of the station device 200 and so on.

### A-5-6. Repeat Betting Operation

The player can reproduce the betting status (in other words, the area of the bet and the number of credits bet) of the immediately preceding game by pressing a repeat bet button b3 shown in FIG. 11. The repeat bet button b3 is set to be operable only immediately after the start of the betting time.

### A-5-7. Bet Unit Switching Operation

Chips indicating “10”, “50”, “100”, and “1000” as credit units are displayed side by side in a bet unit switching area a4 shown in FIG. 11. The chips are displayed in different colors so that the different types of chips can be ascertained at a glance. Note that when the user selects one of the chips (“100”, for example) by touching the chip, the display of the selected chip is enlarged. As a result, the player can visually confirm the selected chip reliably.

### A-6. Description of Jackpot

A jackpot of the dice game according to this embodiment will now be described. In this embodiment, the player can win a jackpot when a position selected in a first draw from among possible betting positions respectively indicating a plurality of possible bet targets (for example, “Big” and “Small”) relating to the numbers on the upturned faces of the dice D matches a position determined (selected in a second draw) in accordance with the numbers on the upturned faces of the dice D.

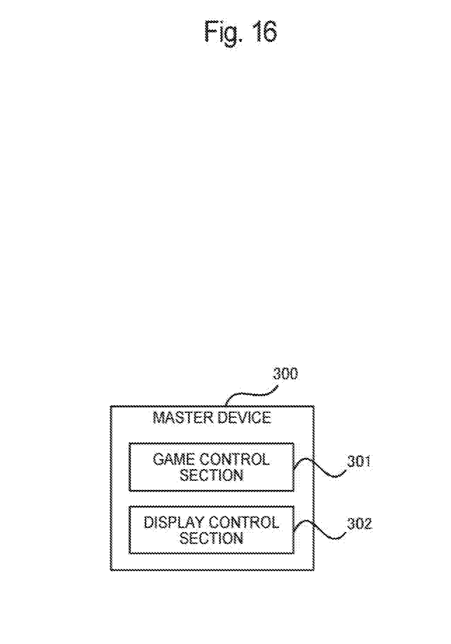

Referring to FIG. 16, functional configurations of the master device 300 for realizing processing relating to the jackpot will be described. As shown in the figure, the master device 300 comprises a game control section 301 and a display control section 302 as the functional configurations for realizing the processing relating to the jackpot. These functional configurations are realized in the main control section 310 by having the CPU 311 expand and execute data stored in the ROM 312 or data received from the external device in the RAM 313. Note that the display control section 302 may be provided in the station device 200 instead of the master device 300. At this time, functions of the display control section 302 are realized by processing executed by the station control section 210.

The game control section 301 is a functional configuration for controlling the execution of processing for advancing the dice game. More particularly, the game control section 301 functions as a jackpot control section when controlling the progress of various types of processing from a point at which the betting time starts to a point at which the jackpot is won. The display control section 302 is a configuration for controlling the display on the display device 250 of the station device 200 in accordance with the control executed by the game control section 301. An example of the processing performed from the point at which the betting time starts to the point at which the jackpot is won will be described below.

During the betting time, a screen such as that shown in FIG. 11 is displayed on the display device 250 of the station device 200. Further, the betting board bb (a bet target display section) shown in FIG. 12 is displayed in the regular betting area a1 of FIG. 11.

The Big/Small area a1-1, the Specific Single Dice area a1-2, the Specific Double area a1-3, the Specific Triple area a1-4, the Any Triple area a1-5, and the Three Dice Total area a1-6 are displayed on the betting board bb as a bet target display section for displaying a plurality of possible betting positions respectively indicating a plurality of possible bet targets.

In the Big/Small area a1-1 of the betting board bb, for example, “Big” and “Small” are displayed as the possible betting positions indicating the possible bet targets. When the player predicts that the total value of the three dice D will be “4 to 10”, for example, the player places a bet on “Small” by placing a chip thereon. Further, in the Three Dice Total area a1-6, for example, numerals from “4” to “17” are displayed as the possible betting positions indicating the possible bet targets. When the player predicts that the total value of the three dice D will be “15”, for example, the player can place a bet on “15” by placing a chip in the position where “15” is displayed.

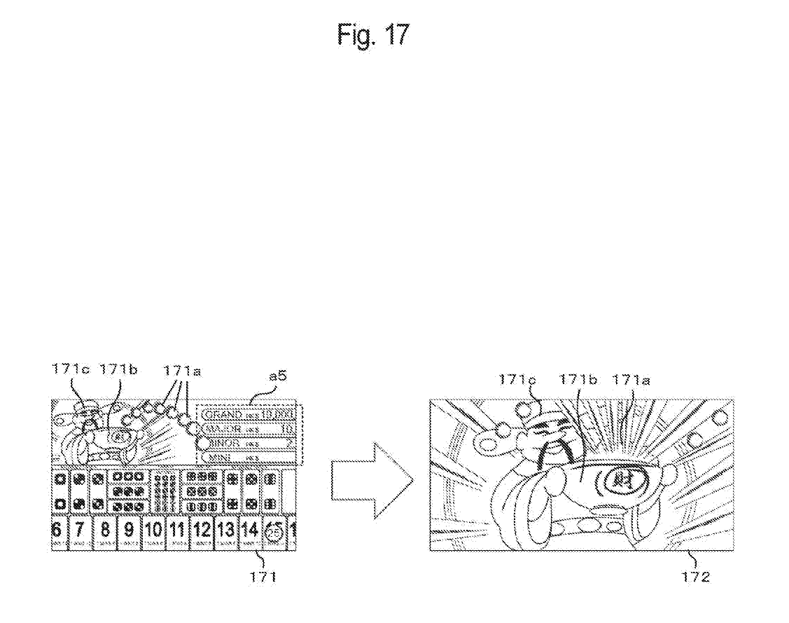

Referring to FIG. 17, examples of screens displayed on the display device 250 when the player places a bet with a chip during the betting time will be described. A screen 171 shows an example of a screen displayed on the display device 250 when a bet is placed by placing a chip in the position displaying the numeral “15” in the Three Dice Total area a1-6. An image of a chip denoting “15” credits is displayed in the position displaying “15” in the Three Dice Total area a1-6. When the player places the bet, an image (a video) of coins 171a entering a receptacle (a container) 171b is displayed under the control of the display control section 302.

A screen 172 shows an image of the coins 171a accumulating in the receptacle 171b. The number of coins 171a entering the receptacle 171b varies according to the value of the bet placed by the player. For example, when the value of the bet is high, an image in which a larger number of coins 171a accumulate in the receptacle 171b such that a higher pile of coins 171a sparkle on top of the receptacle 171b is displayed. Thus, the image of the coins 171a and the receptacle 171b functions as an indicator image indicating the value of the bet. By displaying animations in the manner described above, the player can enjoy more vivid animations by placing a bet of a higher value.

Further, as well as having a larger number of coins 171a accumulate in the receptacle 171b as the value of the bet increases, a larger number of coins 171a may accumulate in the receptacle 171b in response to another element. For example, the number of coins 171a that accumulate in the receptacle 171b may be modified according to the location in which the player places the bet (the possible betting position in which a chip is placed). More specifically, when a bet is placed in a position having a high deduction rate (a rate at which a fee is deducted) or a position having a low winning rate, the display control section 302 can execute control to display a moving image on which a larger number of coins 171a accumulate.

Note that in this embodiment, the value of the bet is indicated by displaying a moving image (serving as an indicator image) of the coins 171a accumulating in the receptacle 171b on the display device 250 under the control of the display control section 302, but the present disclosure is not limited thereto, and any moving image in which an object accumulates in a receptacle may be displayed. For example, a moving image showing a liquid or nuggets as objects other than coins may be used.

Further, the display control section 302 may display different types of receptacles 171b depending on the value of the bet. For example, a receptacle 171b that is larger and/or has a more luxurious outer appearance may be displayed as the value of the bet increases.

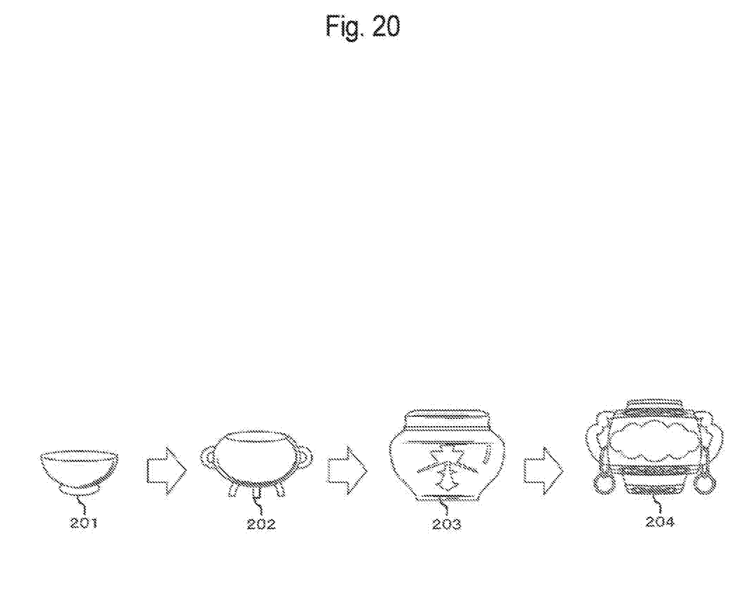

Referring to FIG. 20, examples of receptacles 171b that vary in type according to the value of the bet will be described. First, when a bet has not yet been placed, a receptacle 201 is displayed on the display device 250. Next, when a bet having a value no smaller than a first threshold is placed, a receptacle 202 is displayed in place of the receptacle 201. Next, when a bet having a value no smaller than a second threshold is placed, a receptacle 203 is displayed, and when a bet having a value no smaller than a third threshold is placed, a receptacle 204 is displayed.

Furthermore, in this embodiment, the jackpot is provided at a plurality of levels (in a plurality of types). As the level of the jackpot increases, the dividend also increases. The level of the jackpot to be applied to the game currently being played is drawn in accordance with the value of the bet. In other words, as the value of the bet increases, the likelihood of a higher level jackpot being applied also increases.

Returning to FIG. 17, as indicated by a jackpot display area a5 on the screen 171, the jackpot according to this embodiment is provided in four types, namely “GRAND”, “MAJOR”, “MINOR”, and “MINI”, in descending order of the jackpot level. An image showing the level of the jackpot determined in accordance with the value of the bet is prominently displayed.

Moreover, in this embodiment, a side bet area a6 such as that shown in FIG. 11 is displayed on the display device 250 during the betting time. When the player places a bet by placing a chip in the side bet area a6, a number of coins 171a corresponding to the value of the bet enter the receptacle 17b. The level of the jackpot is determined likewise in consideration of the value of the bet placed in the side bet area a6. When a bet is placed in the side bet area a6, the number of coins 171a entering the receptacle 17b is larger than when a bet of the same value is placed in the regular betting area.

At the end of the betting time, the game control section 301 selects a jackpot winning position in a first draw from among all (or some) of the plurality of possible betting positions (the positions indicated by the areas a1-1 to a1-7, such as “4” to “17” in the Three Dice Total area a1-6, for example).

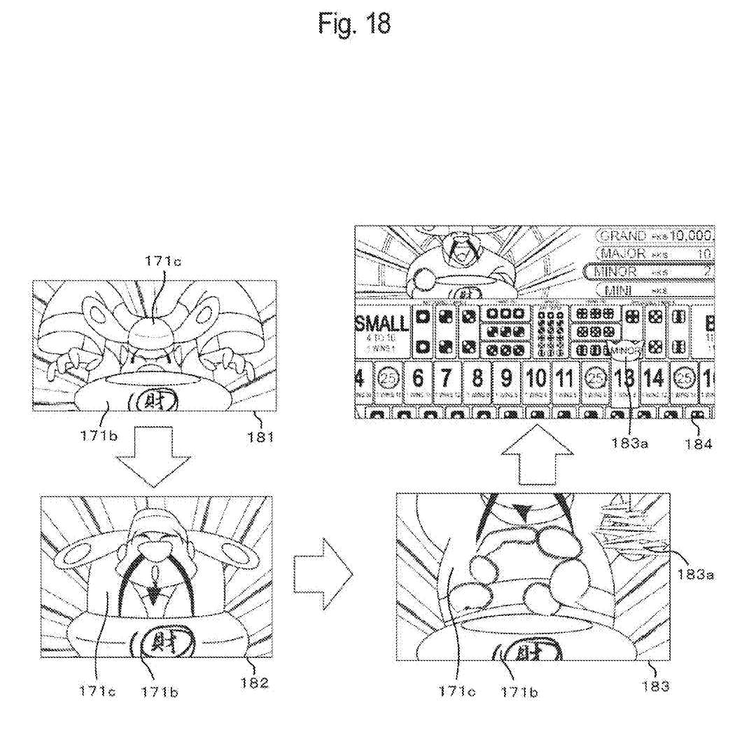

Referring to FIG. 18, examples of animated screens displayed on the display device 250 from the end of the betting time to selection of the jackpot winning position will be described. FIG. 18 shows screens 181 to 184 displayed on the display device 250. As shown by the screens 181 and 182, a moving image showing an operation performed by a character 171c to extract an object from the receptacle 171b is displayed. Next, as shown by the screen 183, an operation performed by the character 171c to throw a symbol 180a extracted from the receptacle 171b is displayed. As shown by the screen 184, by displaying a moving image showing the thrown symbol 180a landing on the position selected in the first draw from among the plurality of possible betting positions (in other words, showing a symbol image moving from an initial position to the position selected in the first draw), the jackpot winning position is displayed prominently. The position on which the symbol 180a is placed serves as the jackpot winning position. By displaying animations in this manner, the player can be informed of the jackpot winning position more clearly.

In the example shown on the screen 184, the symbol 180a (a jackpot winning position display section) is placed in the position displaying “13” in the Three Dice Total area a1-6, whereby the position displaying “13” is displayed prominently as the jackpot winning position. Further, “MINOR” is written in the placed symbol 180a, thereby indicating that the jackpot level to be applied to the game currently being played is “MINOR”. Furthermore, another desired method may be employed to display the jackpot winning position prominently, such as causing the winning position to flash.

According to this embodiment, as described above, the jackpot winning position is selected in the first draw from among all of the plurality of possible betting positions (the positions indicated in the areas a1-1 to a1-7) set in advance. In this embodiment, therefore, the condition for winning the jackpot is wider than in a conventional case where the condition for winning the jackpot is limited to a special condition that rarely occurs, such as matching upturned faces on the dice. Hence, the player can be more hopeful of winning the jackpot, and as a result, the game becomes more entertaining.

Note that when the dice game according to this embodiment is played simultaneously by a plurality of players, the game control section 301 may execute the first draw such that the selected jackpot winning position is different for each player, thereby preventing simultaneous duplicate wins by a plurality of players. Conventionally, when a plurality of players win a jackpot simultaneously, the obtained prize (the income) may be distributed among the players. However, by determining the jackpot winning position to be different for each player as described above so as to prevent duplicate wins by a plurality of players, a player does not win the jackpot at the same time as another player, and therefore the obtained prize does not decrease in value. Here, according to this embodiment, the players include a virtual player employed when the game is played automatically by a computer (under the control of the game control section 301).

After determining the jackpot winning position, the game control section 301 determines the numbers on the upturned faces of the dice D in a second draw. The game control section 301 then determines whether or not the player has won the jackpot in accordance with the position selected from among the plurality possible betting positions in accordance with the numbers on the upturned faces of the dice D, this position being determined by the second draw, and the jackpot winning position. When it is determined that the jackpot has been won, the display control section 302 indicates that the player has won the jackpot on the display device 250.

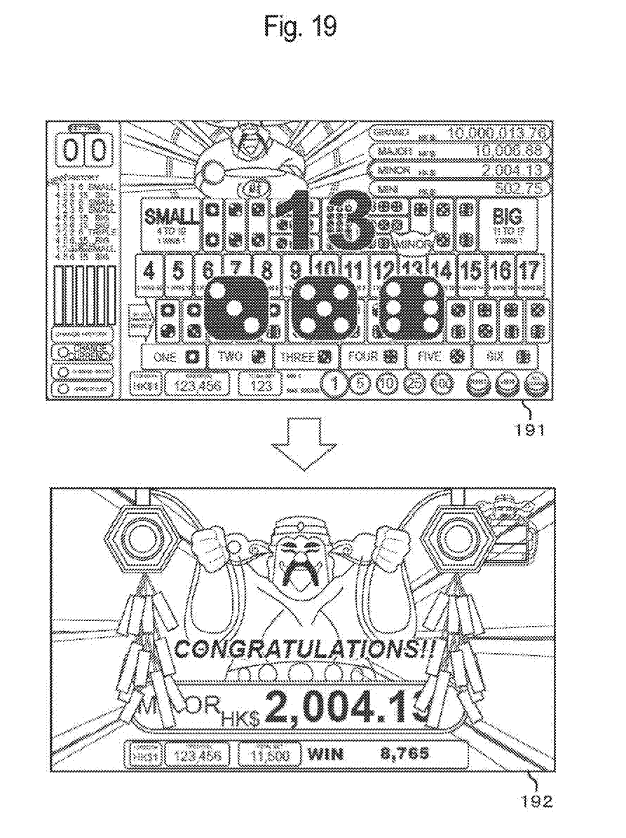

Referring to FIG. 19, examples of animated screens displayed on the display device 250 when the jackpot is won after determining the jackpot winning position in the example described with reference to FIG. 18 will be described. FIG. 19 shows screens 191 and 192 displayed on the display device 250. The screen 191 shows that the numbers on the upturned faces of the three dice D, as determined in the second draw, are “3”, “5”, and “5”, respectively, and that the sum thereof is “13”. At this time, “13”, i.e. the sum of the numbers on the upturned faces of the dice D, matches the jackpot winning position, i.e. “13” in the Three Dice Total area a1-6. Hence, the position determined in accordance with the numbers on the upturned faces of the dice D, as determined in the second draw, matches the jackpot winning position, and therefore the game control section 301 determines that the player has won the jackpot. In accordance with the determination result, the display control section 302 indicates that the player has won the jackpot on the display device 250, as shown by the screen 192. For example, an image (a win notification section) showing the word “CONGRATULATIONS!” is displayed on the screen 192 to indicate that the player has won the jackpot. The player then receives an incentive corresponding to the won jackpot.

### A-7. Description of Processing Flow

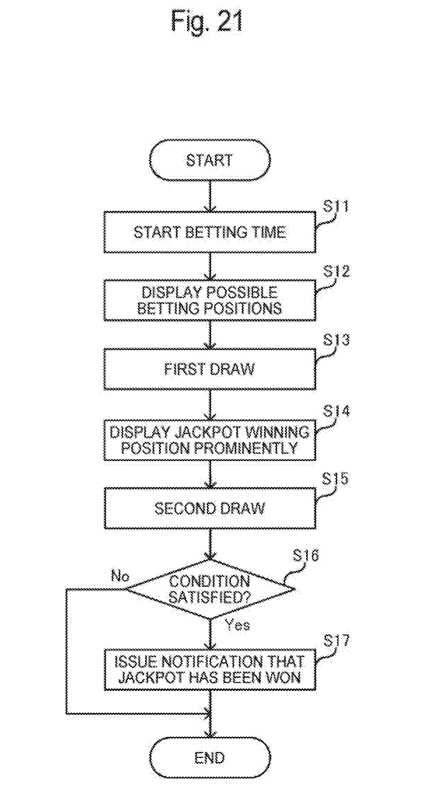

Referring to FIG. 21, a flow of processing relating to the jackpot in the dice game according to this embodiment will be described. This processing is realized in the main control section 310 of the master device 300 by having the CPU 311 expand and execute data stored in the ROM 312 or data received from the external device in the RAM 313, and so on. Note that respective processing steps included in the processing flow to be described below may be executed in an arbitrarily modified sequence or in parallel, and other steps may be added between the processing steps, provided that no inconsistencies occur in the processing content. Moreover, a step described for convenience as a single step may be executed over a plurality of steps. Furthermore, steps described for convenience as a plurality of steps may be understood as a single step. Note that the processing executed in the respective processing steps has already been described, and therefore detailed description thereof has been omitted.

First, the main control section 310 executes control to start the betting time of the dice game in step S11 and control to display the possible betting positions on the display device 250 in step S12. Examples of the possible betting positions are as described above with reference to FIG. 12. When the betting time starts, the player can place a bet by placing a chip on any of the possible betting positions in accordance with the predicted numbers on the upturned faces of the dice.

At the end of the betting time, the main control section 310 executes the first draw in step S13, and in accordance with the draw result, selects the jackpot winning position from among all of the plurality of possible betting positions (the positions indicated by the areas a1-1 to a1-7, such as “4” to “17” in the Three Dice Total area a1-6, for example).

In step S14, the main control section 310 prominently displays the position selected in the first draw from among the plurality of possible betting positions as the jackpot winning position. An example of a method for displaying the jackpot winning position prominently is as described above with reference to FIG. 18.

In step S15, the main control section 310 executes the second draw, and determines the numbers on the upturned faces of the dice D in accordance with the draw result. In step S16, the main control section 310 determines whether or not the player has won the jackpot in accordance with the position selected from among the plurality possible betting positions in accordance with the numbers on the upturned faces of the dice D, this position being determined by the second draw, and the jackpot winning position.

When it is determined in step S16 that the jackpot has been won, the main control section 310 indicates that the player has won the jackpot on the display device 250 in step S17. The player then receives an incentive (credits or the like) corresponding to the won jackpot under the control of the main control section 310.

Note that although a case in which the processing shown in FIG. 21 is executed by the main control section 310 was described above, the present disclosure is not limited thereto, and some or all of the processing shown in FIG. 21 may be executed by the station control section 210 of the station device 200.

According to this embodiment, as described above, the jackpot winning position is selected in the first draw from among all (or some) of the plurality of possible betting positions set in advance. In this embodiment, therefore, the condition for winning the jackpot is wider than in a conventional case where the condition for winning the jackpot is limited to a special condition that rarely occurs, such as matching upturned faces on the dice. Hence, the player can be more hopeful of winning the jackpot, and as a result, the game becomes more entertaining.

### B. Application Examples

As noted above, the present disclosure is not limited to the above embodiment and aforementioned modified examples, and may be subjected to various amendments within a scope that does not depart from the spirit thereof. For example, the master device 300 and the station device 200 shown in FIG. 1 may be constituted by mobile computers, portable terminals, game devices, or the like that can be connected to the network 400, even when differences occur in a processing capacity and so on thereof. In other words, various communication devices connected via the network 400 can be caused to function as the master device 300 and the station device 200.

Further, either a wireless LAN device or a wired LAN device may be employed as a network interface in the master device 300, the station device 200, and the dice throwing device 100, and the LAN device may be an internally mounted device or an external device such as a LAN card.

Furthermore, in this embodiment, the dice throwing device 100 that performs actual dice throws using the dice D is employed, but the present disclosure is not limited thereto, and may also be applied to a game system that performs dice throws under the control of a computer. In this case, a dice throwing function can be installed in the master device 300 so that the dice throwing device 100 can be omitted. Furthermore, by installing a dice throwing function in each of the station devices 200, the present disclosure can be realized by the station devices 200 alone (in other words, in a standalone form).

Moreover, in this embodiment, a dice game using the dice D was described as an example of a game, but the present disclosure is not limited thereto, and may be applied to various different types of games, such as a roulette game using a roulette wheel on which betting operations are performed or a card game using cards.

Furthermore, in this embodiment, a plurality of types of jackpots are provided and the jackpot is selected by a draw, but the jackpot may be determined in accordance with the value of the bet. For example, the jackpot may be determined such that a higher level jackpot is applied as the value of the bet increases.

### INDUSTRIAL APPLICABILITY

As described above, the game machine, dice game system, and dice game control program according to the present disclosure can make a game using dice or the like considerably more fun, entertaining, and interesting than a conventional game machine and so on, thereby improving the sense of participation of a player in the game and the desire of the player to continue the game. As a result, the game machine, dice game system, and dice game control program according to the present disclosure can be employed widely and effectively in all areas of technology pertaining to software and hardware related to the provision, implementation, and so on of games, as well as activities relating to the design, manufacture, sale, and so on thereof.

1. A game system comprising a display control section for executing control in order to display:
a bet target display section for displaying a plurality of possible betting positions respectively denoting a plurality of possible bet targets;
a jackpot winning position display section for prominently displaying, as a jackpot winning position, a position selected in a first draw from among the plurality of possible betting positions; and
a win notification section for indicating that the jackpot has been won in accordance with a position determined in a second draw from among the plurality of possible betting positions and the jackpot winning position.

2. The game system according to claim 1, wherein the display control section displays an indicator image showing objects accumulating in a receptacle in accordance with a value of a bet.

3. The game system according to claim 2, wherein the display control section displays the receptacle in different types according to the value of the bet.

4. The game system according to claim 3, wherein prominently displaying the position selected in the first draw includes displaying a moving image showing a symbol image moving from an initial position to the position selected in the first draw.

5. The game system according to claim 4, wherein the jackpot includes a plurality of types, and the type of the jackpot is selected according to a value of a bet.

6. The game system according to claim 5, comprising a jackpot control section for executing control to ensure that, when a plurality of players are playing, the position selected in the first draw is different for each player so that the jackpot is not won in duplicate by a plurality of players.

7. A control method implemented in a game system comprising a control section, wherein the control section:
displays a plurality of possible betting positions respectively denoting a plurality of possible bet targets;
prominently displays, as a jackpot winning position, a position selected in a first draw from among the plurality of possible betting positions; and
indicates that the jackpot has been won in accordance with a position determined in a second draw from among the plurality of possible betting positions and the jackpot winning position.

8. A non-transitory recording medium storing a program for causing a computer comprising a control section to function as a game system, the program causing the control section to execute control in order to display:
a bet target display section for displaying a plurality of possible betting positions respectively denoting a plurality of possible bet targets;
a jackpot winning position display section for prominently displaying, as a jackpot winning position, a position selected in a first draw from among the plurality of possible betting positions; and
a win notification section for indicating that the jackpot has been won in accordance with a position determined in a second draw from among the plurality of possible betting positions and the jackpot winning position.
